(19) United States
(12) Patent Application Publication
(10) Pub. No.: US 2004/0158584 A1
(43) Pub. Date: Aug. 12, 2004

(54) Information sharing system for geographical data

(76) Inventors: Dorel Marius Necsoiu, San Antonio, TX (US); Brandi Winfrey, San Antonio, TX (US)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/725,249

(22) Filed: Dec. 1, 2003

Related U.S. Application Data
(60) Provisional application No. 60/439,689, filed on Jan. 13, 2003.

(51) Int. Cl. G06F 17/00

(52) U.S. Cl. 707/104.1

(57) ABSTRACT

A method and system for accessing geodata. Geodata input (source) files in various formats are converted to downloadable archive files. The input files are also used to derive metadata file associated with maps represented by the geodata. The archive files and associated metadata files are stored in a repository. A metadata harvester accesses the metadata in the repository and builds a database. A web server and web-enabled end user computer communicate via the Internet to provide the user with an interactive interface for searching the metadata database. The user is provided with metadata and links to the archive files.

### RELATED PATENT APPLICATION

This application claims the benefit of U.S. Provisional Application Serial No. 60/439,689, filed Jan. 13, 2003 and entitled “Information Sharing System for Geographical Data”.

### GOVERNMENT LICENSE RIGHTS

The U.S. Government has a paid-up license in this invention and the right in certain circumstances to require the patent owner to license others on reasonable terms as provided for by the terms of Contract No. NRC-02-97-009 for the Nuclear Regulatory Commission.

### TECHNICAL FIELD OF THE INVENTION

This invention relates to geographic information systems, and more particularly to a database system for storing and accessing geographical data.

### BACKGROUND OF THE INVENTION

A growing field of application software is “geographic information systems” (GIS) software. A GIS system is an information system that is designed to work with data referenced by spatial data or geographic coordinates. A full-fledged GIS is both a database system with specific capabilities for spatially-referenced data, as well as a set of tools for accessing the data.

Comprehensive GIS software systems are commercially available, and comprise a complete set of data collection, storage, and access tools. An example of such a system is the ArcInfo® system, a product of Environmental Systems Research Institute (ESRI®), Inc.

### SUMMARY OF THE INVENTION

The geographic data information sharing system in accordance with the invention is a web-based system that allows access to source geodata. It uses established data standards and supports output of the geodata in multiple formats.

Features of the system include: the ability to ingest different data formats, low cost design due to open-source and commercial off-the-shelf software, seamless management of geodata, controlled access to the data, and scalable architecture. The system can be easily adapted to small and mid-size enterprises that deal with heterogeneous geographic data.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates the overall architecture of a geographical information system in accordance with the invention.

FIGS. 1A and 1B illustrate conversion of input files to archive files.

FIG. 2 illustrates the metadata harvester of FIG. 1 in further detail.

FIG. 3 illustrates the login page of the graphic user interface of the client computer of FIG. 1.

FIG. 4 illustrates the search form of the graphic user interface of the client computer of FIG. 1.

FIG. 5 illustrates the search results page of the graphic user interface of the client computer of FIG. 1.

FIG. 6 illustrates the HTML metadata page of the graphic user interface of the client computer of FIG. 1.

FIG. 7 illustrates the ASCII text metadata page of the graphic user interface of the client computer of FIG. 1.

### DETAILED DESCRIPTION OF THE INVENTION

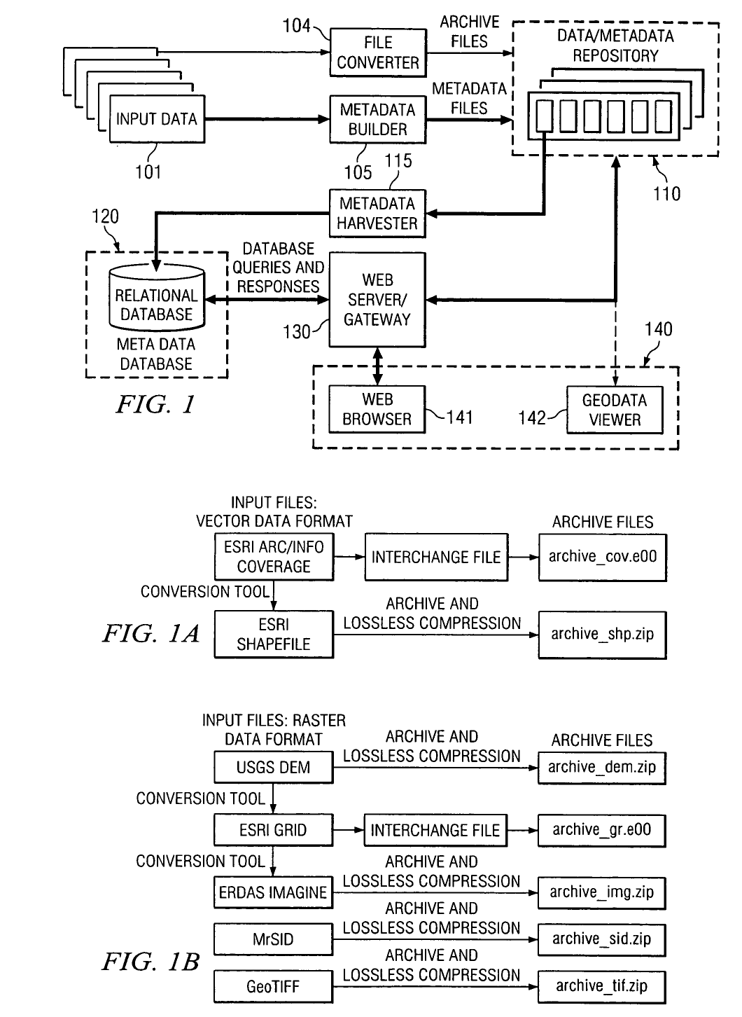

FIG. 1 illustrates the overall architecture of a geographical information system 100 in accordance with the invention. As explained below, system 100 is used by one or several operators who collect and create metadata, operating one or several workstations equipped with metadata builders 105. These operators create a repository 110 of metadata and geodata files. The repository 110 is accessed by harvester 115, which creates a searchable metadatabase 120. System 100 is also used by “end users”, operating internet-enabled computers 140 equipped with a web-browser 141 for displaying a special graphic user interface for searching metadatabase 120 and a viewer 142 for viewing source data downloaded from repository 110.

In the example of this description, repository 110 is an “in-house” repository, and metadata is created and stored via an Internet/Intranet connection. An example of a suitable platform for metadata harvester 115 is one or more workstations, such as those available from SGI® and its IRIX® operating system. Other platforms such as Windows® NT and Linux could be used. However, system 100 may be easily extended for remote access between workstations 105 and 115 and for remote access to additional repositories, via the Internet/Intranet.

The input data 101 is geographic (spatial) data, and may be various formats. A feature of the invention is that raster (aerial and satellite images), vector (maps and illustrations), and tabular (table) formats are supported.

File converter 104 converts input data files into archive files, which are stored in repository 110. File conversion is for the purpose of distributing and storing geodata files, without modifying/altering the information content. Each archive file is “downloadable” in the sense that it is suitable for generating a map, which may be communicated to a user's computer 140, and displayed with the aid of a desktop viewer 142.

FIG. 1A illustrates the conversion of input data 101 in vector data format. One example of this type of input data 101 is an ArcInfo® coverage dataset. This dataset is converted to an ArcInfo® export interchange file format, having an extension .e00. For quick visualization purposes, the coverage could also be converted to an ESRI® Shapefile format and compressed in a .zip file format.

FIG. 1B illustrates conversion of raster input data 101, such as data having ERDAS® Imagine (.img) format. For quick visualization purposes, other formats such as USGS DEM and ESRI® grid formats may be converted to .img format, using commercially available file conversion tools. Additional raster type formats include the MrSID® (.sid) and GeoTIFF (.tif) formats. These formats are then archived and unlossy compressed to .zip file formats.

The files stored in repository 110 are not limited to those explicitly illustrated in FIGS. 1A and 1B. Many different types of input data 101 may be converted to downloadable formats. Examples of these additional formats include, without limitation, JPEG, ERDAS® 7.5 LAN and Raw, BIL, BIP, BSQ, ER mapper, DTED Level 1 and Level 2, ARDG Image, ARDG Overview, ADRG Legend, PNG, NTIF, CIB, and CADRG files.

A feature of system 100 is that the file conversion provides downloadable files, but does not otherwise alter the source data. For quick visualization purposes, some file formats may be converted (see the ArcInfo® coverage or the USGS DEM format). In this case, the end user will have the option to download a) raw (source) data, packaged in a .zip file format or b) processed data in a format suitable for a quick visualization.

Metadata builder 105 accesses the input data 101 and permits the operator to document a geodataset by entering data to an associated metadata file. “Metadata” is “data about data”, and comprises information about the geodataset such as its content, quality, condition, and origin. Metadata facilitates data identification by search and retrieve mechanisms, based on a user's selection criteria. It permits a user to easily understand the content of a geodataset and to evaluate its usefulness, without actually viewing the contents of the geodataset.

The metadata of the present invention comprises details useful for both data managers and geodata users. For data managers, the metadata comprises information about data format, internal structures, and data definitions. For users, the metadata comprises “catalog” type information, such as where to find data, how to use it, and who originated it.

The metadata is compliant with the Federal Geographic Data Committee Content standards for Digital Geospatial Metadata (FGDC).

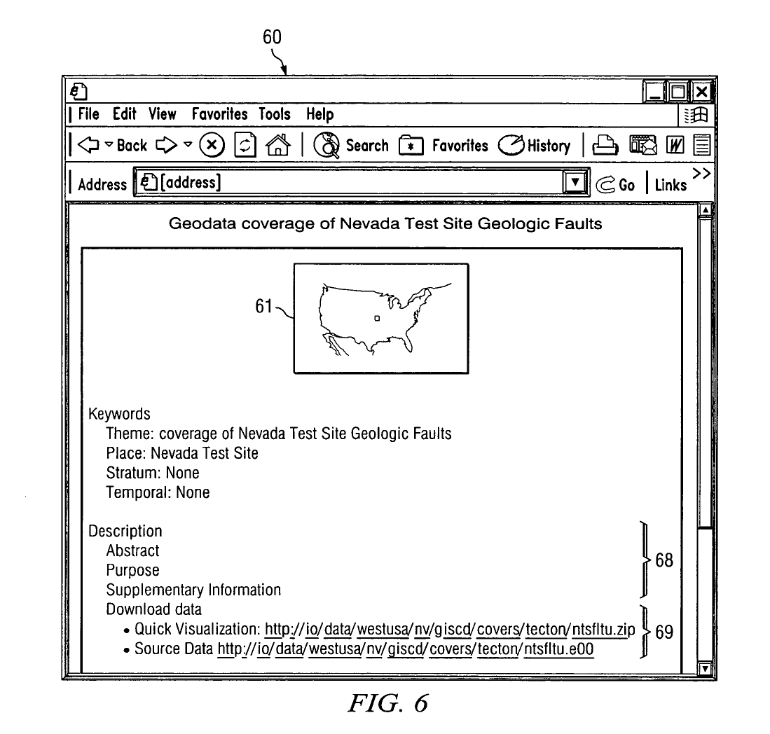

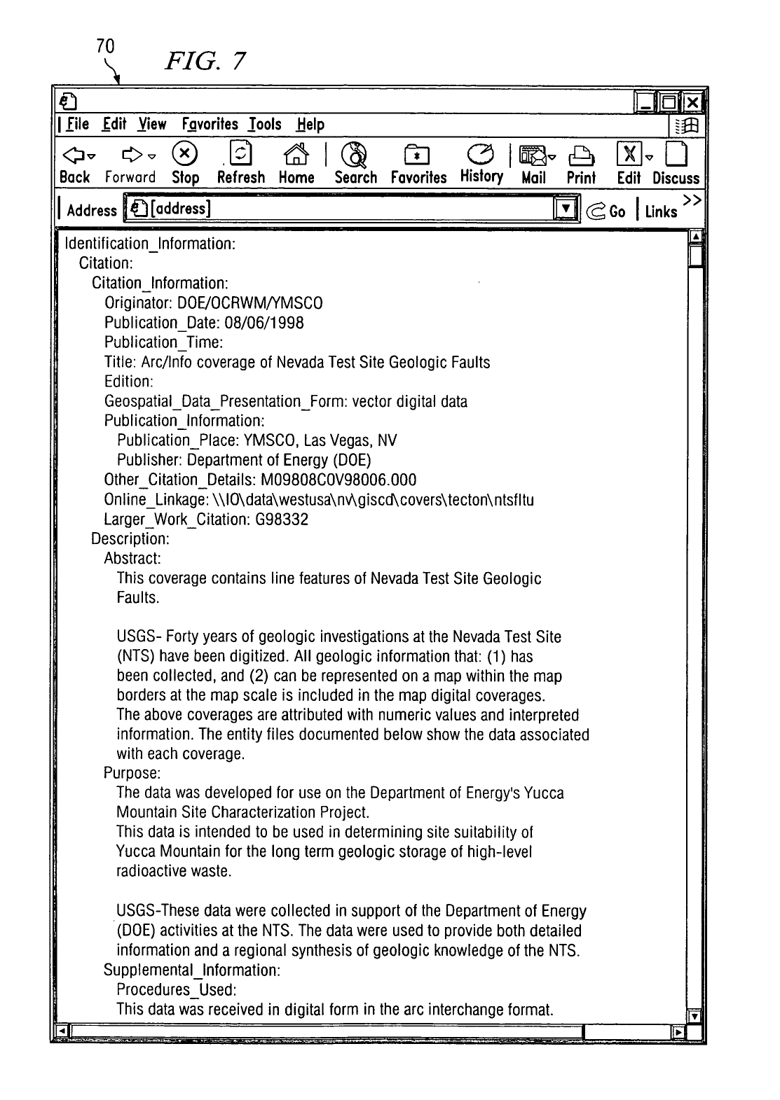

Thus, metadata builder 105 enables the creation and editing of metadata and its export to repository 110. With metadata builder 105, the operator may retrieve geodata files and view the data in map form. A metadata editor is used to document the geodata, by filling in available categories and prompting the user for additional descriptive data. Specific metadata fields are described below in connection with FIG. 6. An example of a suitable metadata builder 105 is ArcCatalog, a commercially available product of ESRI®, Inc.

As stated above, repository 110 stores a downloadable “archive” file corresponding to each geodataset from the input files 101. For each geodataset represented by one or more input data files, its metadata points to the location of a downloadable archive file in repository 110.

Each metadata file is stored in both an XML (extensible Markup Language) and HTML (Hyper text Markup Language) format. Typically, the metadata files provided by metadata builder 105 are XML files, and are reformatted to HTML files for creating the user interface described below in connection with FIG. 6.

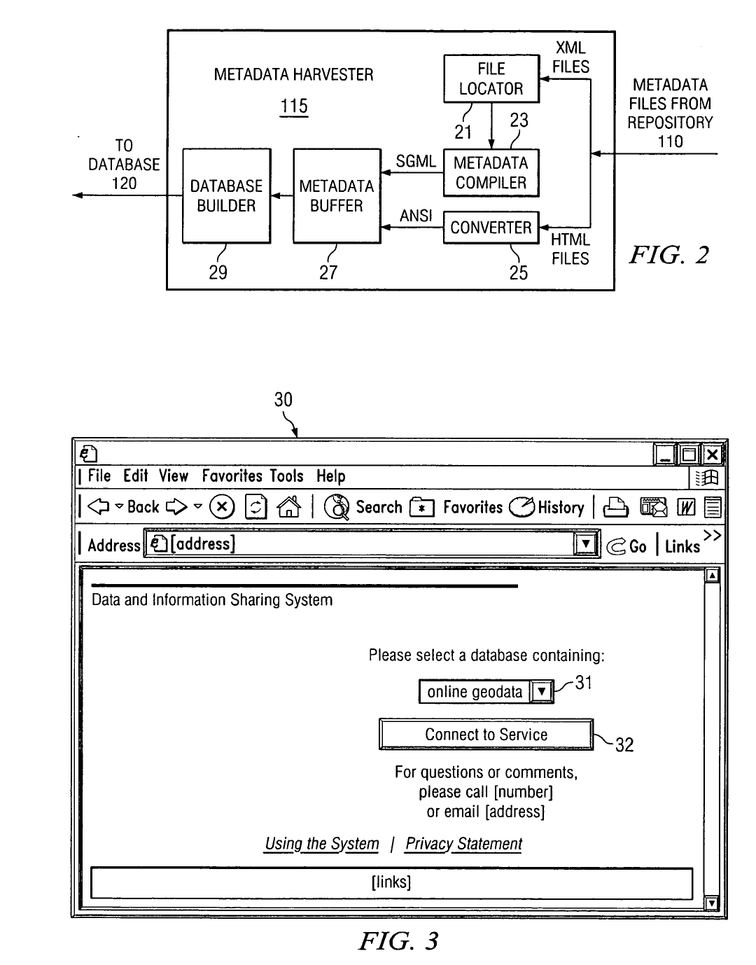

Metadata harvester 115 retrieves metadata files from repository 110. As explained further below in connection with FIG. 2, harvester 115 compiles the metadata and builds a database of the metadata.

Harvesting is performed on a periodic basis, such as on a daily basis. The architecture and function of harvester 115 is explained in further detail below in connection with FIG. 2.

Harvester 115 delivers the metadata to metadata database 120. Database 120 is a relational database, which means that it stores all its data inside tables. All operations on data are done by changing data in the tables themselves or by producing new tables as the result of operations on existing tables.

Database access for end users of system 110 is by means of a web server 130, to which the user connects via the Internet, a desktop computer, and a web browser. An example of a suitable web server 130 is the Apache web server, a public domain open source web server.

The protocol for retrieval from database 120 is the ANSI/NISO Z39.50 standard, the American National Standard for information retrieval. Z39.50 is a computer-to-computer communications protocol designed to support searching and retrieval of information—full-text documents, bibliographic data, images, multimedia—in a distributed network environment. It is based on client/server architecture and operates over the Internet.

An example of a suitable web-based data access system for web server 130 is Isite®, an integrated Internet publishing software package. Isite is public domain software, available from The Center for Networked Information Discovery and Retrieval (CNIDR). Isite includes a text indexer/search system (Isearch) and Z39.50 communication tools to access databases. Zserver is Isite's server, and Zgate its Internet gateway.

The search interface is a Z39.50 compliant interface, such as the Zgate software. The Zgate interface is a web-based interface that provides concurrent search capabilities over all, or a selection of, local or Internet-based Z39.50 databases.

The end user's computer system 140 is equipped with a web browser and a geodata viewer. The user interface for querying database 110 is described below in connection with FIGS. 3-6. As explained below, once the user selects a particular geodataset for viewing, the data is downloaded to the user's computer.

The geodata viewer is capable of displaying geodata in one or more of the various formats described below in connection with FIG. 2. The viewer may have an integrated tool for decompressing the .zip format, or may work in conjunction with such a tool. An example of a suitable data viewer is ARCExplorer, available from ESRI®, Inc.

FIG. 2 illustrates harvester 115 in further detail. As stated above, for each metadata file created by metadata builder 105, repository 110 stores both and XML and an HTML version of that file.

Harvester 115 is programmed to retrieve both types of files. This may be performed in response to a command by an operator of the computer executing the harvester programming, or automatically on a periodic basis. For example, the harvester programming may operate in conjunction with a “cronjob” such as are used in UNIX® type systems. Periodic harvesting of metadata files from repository 110 may be performed so that only “new” files are retrieved each time.

XML files are retrieved by a file locator 21. The XML files are then delivered to a metadata compiler 23.

An example of a suitable metadata compiler 23 is the MP metadata compiler, a pubic domain software tool developed by the USGS. It parses formal metadata, checking the syntax against the FGDC Content Standard for Digital Geospatial Metadata and generates output suitable for viewing with a web browser or text editor. It runs on UNIX® systems and on PC's running Windows® 95, 98, or NT. It generates a textual report indicating errors in the metadata, primarily in the structure but also in the values of some of the scalar elements (i.e. those whose values are restricted by the standard).

HTML files are received as Unicode files by a converter 25, which converts them to ANSI format.

The compiled/converted metadata is delivered to buffer 27. A database builder 29 formats the data for storage in database 120.

FIG. 3 illustrates the user interface accessed via the user's web browser 141. In the example of this description, the user interface is displayed using a windows-type internet access software, such as the Internet Explorer® software, available from Microsoft Corporation.

FIG. 3 illustrates a login page 30. As illustrated, the user is presented with a choice of databases 31 and a button for activating access to server 130.

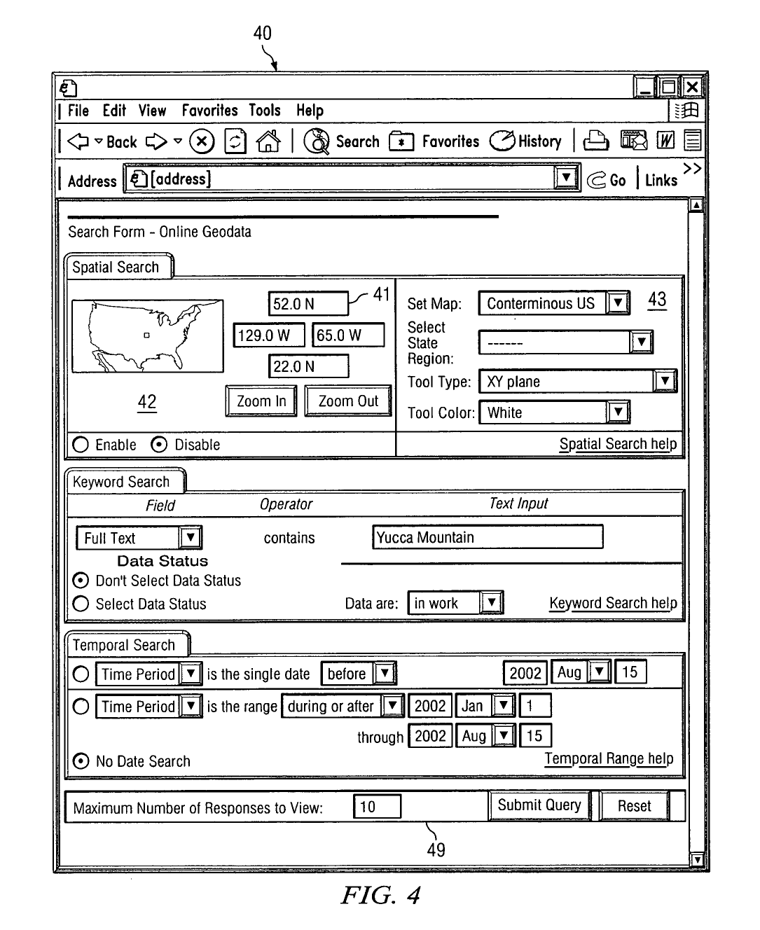

FIG. 4 illustrates a search form 40, which appears after the user selects “online geodata” from the menu 31 of FIG. 3. As illustrated, the search capabilities include spatial, keyword, and temporal searching. These options may be used independently or in conjunction with each other.

Spatial searches allow various methods of entering data for queries. The user may enter geographic coordinates into text fields 41. The user may alternatively select a desired location on a map 42. If a map 42 is used, map menu selections 43 can be used to select map attributes, such as color and style. Examples of map styles are point, compressed x and y, and xy plane.

After composing a search query, the user may specify the number of responses to view on the results page, using the submit section 49. The user submits the search to server 130, which then accesses and searches database 120.

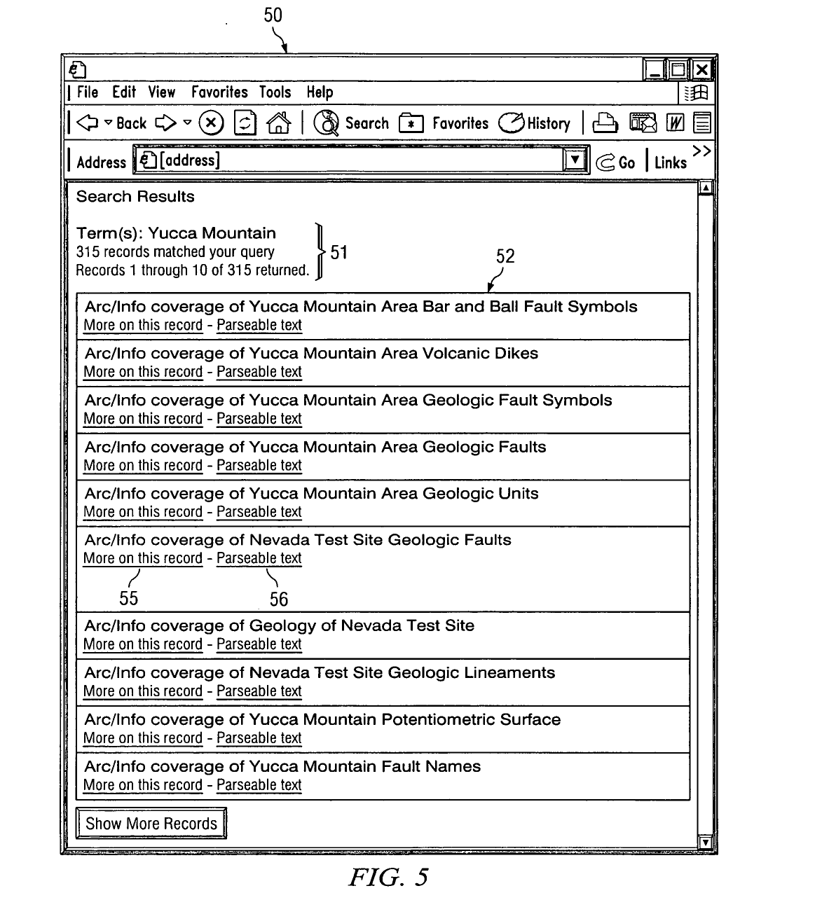

FIG. 5 illustrates an example of a search results page 50, which displays the search results returned by server 120 and communicates to the web browser 141. A search summary section 51 displays the term(s) queried, the number of matching records found, and the number of records currently being viewed. A list of records 52 containing titles of records that satisfy the query follows the summary section.

Each record is accompanied by two links to metadata describing the available data. A first link 55 is to an HTML metadata page. A second link 56 is to an ASCII text metadata page. From these links, the user may access either type of metadata page. In response to the user's activation of one of these links, server 120 downloads either an HTML metadata page or an ASCII text metadata page.

FIG. 6 illustrates an example of an HTML metadata page 60, corresponding to a link 55 on the search results page 50. A thumbnail image of the map associated with the record is displayed 61.

The illustrated metadata description categories 68 are for purposes of example; HTML templates may be used to create a page 60 that has any or every categories of metadata desired for display to the user. In the example of FIG. 6, page 60 is Java® enriched, such that text within topic categories 68, may be hidden or displayed by clicking on the topic heading. For example, by clicking on the “Abstract” heading, the user may view the full text of the abstract.

A download section 69 provides choices of downloadable files. A version of the original data is provided in a format compatible with the geodata viewer 142. For the example of this description, both an .e00 and a .zip file are available. This choices of formats provides the user with an option to view either a converted ArcInfo® file (.e00), containing the original source data, or a compressed file (.zip) in a Shapefile format, containing a truncated version of the data. Various format alternatives may be provided, which may or may not be suitable for the user's particular viewer 142.

A tool such as WinZip® is used to decompress .zip files. The decompression tool may be integrated into the viewer 142, so that the decompression is transparent to the user. Using viewer 142, the downloaded archive file is displayed in map form.

FIG. 7 illustrates a metadata text page 70, which provides an ASCII text version of the metadata. This version of the metadata is displayed in response to the user activating the “parseable text” link 56 on the search results page 50.

What is claimed is:

1. A method of providing access to geodata, comprising the steps of:
using a metadata builder to access geodata input files and to generate metadata files associated with the geodata files;
using a file converter to convert the geodata input files to downloadable archive files;
storing the archive files and metadata files in a repository;
using a metadata harvester to retrieve the metadata files from the repository and to build a metadata database;
storing the metadata database in memory accessible by an internet server; and
using the internet server to: communicate via the Internet with a user's web browser; to receive query data from the web browser; to respond to the queries by accessing the metadata database; to download a results page containing a list of records, each record having a metadata link to metadata associated with the record; to download a metadata page in response to activation of the metadata link, the metadata page containing metadata and at least one link to an archive file; to retrieve an archive file from the repository in response to activation of the link; and to download locally the archive file via a web browser.

2. The method of claim 1, wherein the storing step is performed by storing an XML metadata file and an HTML metadata file for each archive file.

3. The method of claim 1, wherein one or more file formats and archive files are derived from a number of geodata input files.

4. The method of claim 1, wherein the archive files are lossless compressed data files.

5. The method of claim 1, wherein the geodata input files may be any of the following formats: vector, raster, or tabular.

6. The method of claim 1, wherein the metadata database is a relational database.

7. The method of claim 1, wherein the database access is via a Z39.50 server.

8. The method of claim 1, wherein the metadata harvester retrieves metadata on a periodic basis.

9. The method of claim 1, wherein the metadata harvester retrieves only metadata files which are new since a prior harvest.

10. The method of claim 1, wherein the metadata harvester retrieves both XML and HTML metadata files.

11. The method of claim 1, wherein the metadata complies with the FDGC standard or other metadata standards.

12. The method of claim 1, wherein the internet server may receive query data in any one of the following formats: spatial, keyword, or temporal.

13. The method of claim 1, wherein each record has a first metadata link to an HTML metadata file and a second metadata link to an XML file.

14. The method of claim 1, wherein the metadata page further contains a thumbnail image of a map associated with the metadata.
